(19) United States
(12) Patent Application Publication
(10) Pub. No.: US 2025/0108338 A1
(43) Pub. Date: Apr. 3, 2025

(54) SYSTEM AND METHOD FOR WATER PURIFICATION VIA A NANOCOMPOSITE MEMBRANE

(71) Applicant: AAVALOR GREENTECH B.V., Baarn (NL)

(72) Inventor: Aryan Aviraj Mishra, Ranchi (IN)

(21) Appl. No.: 18/834,494

(22) PCT Filed: Jan. 31, 2023
(86) PCT No.: PCT/IB2023/050824

§ 371 Date: Jul. 30, 2024

(30) Foreign Application Priority Data
Jan. 31, 2022 (IN) 202231005203

(51) Int. Cl. B01D 69/12; B01D 71/12; C02F 1/44

(52) U.S. Cl. CPC B01D 69/1213; B01D 71/12; C02F 1/441; C02F 1/445; B01D 2323/26

(57) ABSTRACT

A method of preparing a nanocomposite membrane for water filtration is disclosed herein. The method comprising spraying a nanomaterial substantially over a surface of at least one polymer sheet to form a sprayed polymer sheet. The at least one sprayed polymer sheet is subjected to a heat treatment and dried thereafter. The method further comprises layering the at least one dried sprayed polymer sheet together to form at least one nanocomposite membrane.

### FIELD OF INVENTION

In general, the present disclosure is related to a system and method for water purification. In particular, the invention relates to a system and method of water purification via a nanocomposite membrane.

### BACKGROUND

Water pollution caused by anthropogenic activities is increasing at an alarming rate. The phenomenon has caused severe health issues and reduced the availability of clean water. Water shortage is an urgent problem for many parts of the world. Consequently, there have been a lot of research mainly in the field of water purification. Numerous technologies such as adsorption, biological oxidation and chemical oxidation have been used for the removal of all types of organic and inorganic pollutants. Conventional methods and systems used to eliminate unwanted and toxic contaminants for water purification suffers various limitations such as high energy requirement, incomplete pollutant removal, high water wastage and formation of hazardous waste products.

In light of the above, there exists an utmost requirement for improved methods, and systems for water purification.

### SUMMARY

An object of the present disclosure is to provide a system of water purification via a nanocomposite water purifier membrane.

Another object of the present disclosure is to provide a method of producing nanocomposite membrane for water purification.

In an aspect, embodiments of the present disclosure provide a method of preparing a nanocomposite membrane for water filtration, wherein the method comprising:
spraying a nanomaterial substantially over a surface of at least one polymer sheet to form a sprayed polymer sheet;
subjecting the at least one sprayed polymer sheet to a heat treatment, and drying thereafter the sprayed polymer sheet; and
layering the at least one dried sprayed polymer sheet together to form at least one nanocomposite membrane.

Optionally, the method further comprises winding the nanocomposite membrane around a polymeric skeleton structure.

Optionally, the nanomaterials employed for preparing nanocomposite membrane comprises carbon-based nanomaterials, metal and metallic oxides, non-metallic oxides, metal-organic frameworks and hybrid nanomaterials.

Optionally, the nanomaterials are employed in the form of a cluster, nanotubes, rods, nanosheets, films and polycrystals.

Optionally, the nanocomposite membrane is employed for at least one of a reverse osmosis water filtration process or a forward osmosis water filtration process.

Optionally, the polymer is selected from either a natural polymer or a synthetic polymer.

Optionally, the polymer of the polymer sheet is selected from the group consisting of cellulose-based polymers including cellulose acetate, cellulose triacetate, cellulose acetate proprianate, cellulose butyrate, cellulose acetate propionate, cellulose diacetate, cellulose dibutyrate, cellulose tributyrate, hydroxypropyl cellulose, and nitrocellulose.

Optionally, the polymer of the polymer sheet is selected from the group consisting of polyamide, polybenzimidazole, polyethersulfone, polysulfone, polyvinyl alcohol, polyvinyl pyrrole, polyvinyl pyrrolidone, polyethylene glycol, saponified polyethylene-vinyl acetate copolymer, triethylene glycol, and diethylene glycol.

In a second aspect of the present disclosure, there is provided a filter membrane for providing water filtration, wherein the filter membrane comprising:
a polymeric skeleton structure;
at least one nanocomposite sheet layered together and wound around the polymeric skeleton structure.

Optionally, the polymeric skeleton structure comprising a BPA grade plastic skeleton structure.

Optionally, the polymeric skeleton structure is configured to provide support to the at least one polymer nanocomposite sheet.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

A better understanding of the present invention may be obtained through the following examples which are set forth to illustrate but are not to be construed as limiting the present invention.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a flow diagram of a method of preparing nanocomposite membrane for water filtration, in accordance with an embodiment of the present disclosure.

FIG. 2 is a schematic illustration of a flow diagram of a nanocomposite membrane module, in accordance with an embodiment of the present disclosure;

FIG. 3 is a schematic illustration of a filtration module for water filtration, in accordance with an embodiment of the present disclosure;

FIG. 4 illustrates steps of a method for preparing a graphene-zirconium dioxide-silicon carbide membrane, in accordance with an embodiment of the present disclosure; and

FIG. 5 illustrates an exemplary graphene-zirconium dioxide-silicon carbide membrane module, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In an aspect, embodiments of the present disclosure provide a method of preparing a nanocomposite membrane for water filtration, wherein the method comprising:
spraying a nanomaterial substantially over a surface of at least one polymer sheet to form a sprayed polymer sheet;
subjecting the at least one sprayed polymer sheet to a heat treatment, and drying thereafter the sprayed polymer sheet; and
layering the at least one dried sprayed polymer sheet together to form at least one nanocomposite membrane.

The present disclosure provides the aforementioned water purification system and method that help in enhancing the water purification system, reduction in water wastage, and increase in the durability of the water filtration system. In addition, employing the disclosed water purification system results in increasing the overall working efficiency to purify water. The advantages include the high selectivity, high permeability & flux and anti-fouling properties as compared to other water purification devices. As compared to the other devices and systems, nanomaterial layered with a polymer will show high selectivity. As a result, the efficiency by which contaminants is removed from water, is improved.

Furthermore, the disclosed system provides a water permeable membrane whose nanomaterial component has a 2d flat structure, that results in showcasing high permeability & high transfer of flux. Consequently, the disclosed system allows water to pass very quickly without friction which will enhance the overall efficiency of the water purifier.

In addition, the nano materials employed in the water permeable membrane for water purification, is evenly distributed. Therefore, it shows antifouling property that increases the overall life of the water purifier making it long lasting as compared to other devices. Moreover, the advantages also include the pore size of the nanomaterial being used, that is less than 6 nm. As a result, water is being purified at a nano molecular level and results in purifying all the undesirable compounds from the water at a nano molecular level and purifying it efficiently.

The water purification system as described herein comprises a nanocomposite membrane. Throughout the present disclosure, the term “nanocomposite” as used herein, relates to a group of novel filtration materials that comprise nanofillers and they are embedded in a polymeric or inorganic oxide matrix that functionalizes the membrane. In an embodiment, Nanocomposite membranes are formed when nanoparticles are dispersed into the polymer blend. In an embodiment, the nanocomposite membrane is formed when nanoparticles are dispersed into the polymer blend prior to membrane casting. Nanoparticles may be inorganic, organic (e.g., carbon nanotubes), or hybrid (e.g., functionalized particles). In some cases, this is done primarily to improve electrochemical performance.

Throughout the present disclosure, the term “osmosis” refers the net movement of water across a selectively permeable membrane driven by a difference in osmotic pressure across the membrane. A selectively permeable membrane (or semipermeable membrane) allows passage of water molecules but rejects solute molecules or ions. The semipermeable membrane filters the impurities from a water source (feed solution) which is suspected to contain impurities, leaving purified water on the other side (permeate side) of the membrane called permeate water. The impurities left on the membrane may be washed away by a portion of the feed solution that does not pass through the membrane. The feed solution carrying the impurities washed away from the membrane is also called “reject” or “brine”. In an embodiment, the present disclosure employs either a reverse osmosis or a forward osmosis. The main difference between reverse osmosis and forward osmosis is how water is driven through the membrane. In reverse osmosis, the water is forced through the membrane using hydraulic pressure. Forward osmosis uses natural osmotic pressure to induce the flow of water through the membrane.

The water purification system as described herein comprises a nanomaterial. The nanomaterial is a material with dimensions between 0.0001 and 10000 nm. The size of nanomaterials is closely related to their exceptionally high surface area and surface reactivity. Many of them have shown other interesting properties including superior surface to volume ratio, photocatalytic properties, improved solubility, large surface charge and abundant reactions sites. Nanomaterials are categorized by their size, composition, shape and origin. The uniqueness of these materials promises the design of materials with adjustable properties, with improved properties and performances that are comparable to those of long-established counterparts available in the market. The size of nanomaterials can be affected by several parameters, like the method used for synthesis, temperature, pressure, time, pH and concentration. On the basis of their function, nanomaterials have been synthesized into various dimensions and shapes, including spheres, fibres, tubes, sheets and interconnected architectures. Nanomaterials may be in the form of the zero-dimensional (0D) structure that is characterized by spherical shape, fibers and tubes are the common shapes of one-dimensional (1D) structure, two-dimensional (2D) structure presents in the form of sheet-like structures and interconnected architectures are normally characterized as three-dimensional (3D) structures. The construction of nanostructure materials with multi-dimensions offers very interesting morphologies, properties and functions such as adhesion, adsorption, reflectance and carrier transportation properties for water purification applications.

In an embodiment, the present disclosure uses a 2d nanomaterial structure. In particular, at least one of, but not limited to, graphene or graphene oxide or titania or nanosheet or their combination are used for producing water permeable membranes. In another embodiment, the present disclosure uses a 0d nanomaterial structure. In particular, at least one of clusters of, but not limited to, TiO₂, Al₂O₂, SiO₂, ZnO, Ag or their combinations are used for producing water permeable membranes. In another embodiment, the present disclosure uses a 1d nanomaterial structure. In particular, at least one of clusters of, but not limited to, SWCNTs, MWCNTs, titania, nanotube or their combinations are used for producing water permeable membranes. Furthermore, in another embodiment, 3d polycrystals are being employed for producing water permeable membrane. In particular, at least one of clusters of, but not limited to, zeolite, metal organic framework or their combinations are used for producing water permeable membranes.

According to one of the embodiments of the present disclosure, there is provided a method of preparing a nanocomposite membrane for facilitating water remediation or water purification. The method comprises spraying a nanomaterial substantially over a surface of at least one polymer sheet. In an embodiment, Graphene oxide is solid sprayed evenly over the surface of the polyamide forming a well-distributed layer. Herein, the graphene oxide and the polyamide are acting as a nanomaterial and a polymer sheet respectively. The solid spraying of nanomaterial over the polymer sheet reduces the pore size of the sheet to a great extent. Consequently, the filtration efficiency is increased along with the reduction of water wastage to up to 90-99%.

In an embodiment, the nanomaterials as employed in the above-mentioned method for preparing polymer nanocomposite membrane comprises carbon-based nanomaterials, metal and metallic oxides, non-metallic oxides, metal-organic frameworks and hybrid nanomaterials. In another embodiment, the nanomaterials are employed in the form of a cluster, nanotubes, rods, nanosheets, films and polycrystals.

In an embodiment, the polymer as employed herein on which nanomaterial is being sprayed, is selected from either a natural polymer or a synthetic polymer. In another embodiment, the polymer is further selected from the group consisting of cellulose-based polymers including cellulose acetate, cellulose triacetate, cellulose acetate proprianate, cellulose butyrate, cellulose acetate propionate, cellulose diacetate, cellulose dibutyrate, cellulose tributyrate, hydroxypropyl cellulose, and nitrocellulose. In yet another embodiment, the polymer is selected from the group consisting of polyamide, polybenzimidazole, polyethersulfone, polysulfone, polyvinyl alcohol, polyvinyl pyrrole, polyvinyl pyrrolidone, polyethylene glycol, saponified polyethylene-vinyl acetate copolymer, triethylene glycol, and diethylene glycol.

Furthermore, the at least one sprayed polymer sheet with the nanomaterial is subjected to a heat treatment and dried thereafter. In an embodiment, once the graphene oxide is solid sprayed over the polyamide layers, it is heated and dried. The at least one dried polymer sheet after being subjected to a heat treatment are layered together to form a polymer nanocomposite sheet. In an embodiment, the at least one dried polymer nanocomposite sheet is wind around a polymer skeleton structure. In a particular embodiment, the at least one dried sprayed polymer sheet after layering together are rolled as a cylinder over a polymer skeleton structure. Optionally, the polymer skeleton structure comprises a BPA grade plastic skeleton structure. More optionally, the polymer skeleton structure comprises a BPA grade plastic skeleton cylindrical structure. In an exemplary embodiment, when water pass through these cylinder layers, the resultant membrane purifies all the bacteria, viruses, unwanted compounds and so forth.

According to an embodiment of the present disclosure, the technicality of the disclosed invention lies in the in the combination of material used and the way graphene oxide is used in layers with polyamide. The solid spraying of the graphene oxide evenly over the polyamide layers modifies the water filtration and overall working of the water purifier. As in accordance with an embodiment, the sheets are rolled as a cylinder over a plastic skeleton structure to give proper surface area to the water that is to be purified. Getting proper surface area allows the water to pass through the structure evenly from the outer casing.

The technical difficulty lies in the development of the nanomaterial and polymer nanocomposite membrane sheet and then using the sheets to develop the entire 5 cm module. In an embodiment, the module of nanocomposite membrane is developed as a module in the range of but not limited to, 2-5 cm, 4-7 cm, 6-9 cm, 8-11 cm, 10-13 cm, 12-15 cm and so forth. Since a nanomaterial is employed for preparation of a nanocomposite membrane, it is quite difficult to produce a nanocomposite sheet with equal distribution entirely over the polymer sheet surface and proper layering of it to develop a combined filtration sheet. The above-mentioned problem is being solved by employing the right amount of nanomaterial over the polymer sheet layers by using solid spraying and then heating together to develop at least one sheet. Hence, innovative water filtration module is developed.

The way graphene oxide is being employed with a combination of polyamide gives technical advantage in the water filtration module as in accordance with one of the embodiments of the present disclosure.

As in accordance with an embodiment, the reproduction of the nanocomposite membrane as disclosed herein the present disclosure can be executed easily via the existing infrastructure in relation with the present-day membrane production facilities.

In an embodiment of the present disclosure, there is provided a filter membrane for providing water filtration, wherein the filter membrane comprises a polymeric skeleton structure. The at least one polymer nanocomposite sheet layered together and wound around the polymeric skeleton structure.

Optionally, the polymeric skeleton structure comprises a BPA grade plastic skeleton structure. The polymeric skeleton structure is configured to provide support to the at least one polymer nanocomposite sheet.

According to a further embodiment, there is provided a filtration module as described herein the present disclosure. The filtration module comprises a casing to filter connecting nozzle, an outer casing, filter top cap, one or more activated charcoal disc, a polymer nanocomposite membrane module, a filter bottom cap and a membrane module to a container connecting nozzle.

The Casing to filter connecting nozzle is a connecting nozzle that is used to transfer water that is to be purified from the dirty water holding container to the outer casing of the filter. The outer casing is the part of the filtration module in which the dirty water is filled and collected. The Filter top Cap is the top part of the filter that is connected with the membrane module with push fit and interlocked with threads.

The filtration module further comprises one or more activated charcoal disc that is connected in between the filter cap and membrane module and is attached to enhance the water purification. The water is passed through said disc once the outer casing is completely filled with the water that is to be purified. The polymer nanocomposite membrane module is the core part of the water purifier and the key purpose of membrane module is to filter water.

The polymer nanocomposite membrane module is composed of a nanomaterial (for example, graphene oxide) sprayed or layered over the polymer sheet (for example, polyamide sheet). The sprayed or layered polymer sheet with nanomaterial, is together developed to form a sheet. The sheet is then layered and rolled or wound around a polymer skeleton structure. In a particular embodiment, the sheets are layered and rolled around a cylindrical structure. The cylindrical structure comprises a BPA grade plastic cylindrical skeleton. The food grade plastic cylindrical skeleton is configured to provide support to the nanocomposite membrane sheets to form a proper filtration structure

In an embodiment, the water is purified once the outer casing is completely filled with the dirty water. Since the polymer nanocomposite membrane module is highly permeable in nature, water is passed easily through the sheets wound around the polymer skeleton structure and combined as a module and consequently, the dirty water gets filtered.

The water filtration module further comprises a filter bottom cap that is the bottom part of the filter and is connected with the bottom nozzle connector and the membrane sheet module. The water when purified will pass from nanocomposite membrane module to the filter bottom cap, the water starts entering the bottom nozzle connector therefrom.

In an embodiment, the one or more activated charcoal disc is connected in between the filter bottom cap and the membrane module to container connecting nozzle so as to enhance water purification. Furthermore, the membrane module to container connecting nozzle transfer the purified water from the filtration module to a storage container after the water purification is completed.

In yet another aspect, embodiments of the present disclosure provide a method for preparing a graphene-zirconium dioxide-silicon carbide membrane, wherein the method comprises:
preparing a first mixture comprising zirconium dioxide, silicon carbide, a dispersant, a solvent, and a binder;
mixing the first mixture with a liquid to form a second mixture;
extruding the second mixture using two dies, for obtaining a cylindrical-shaped membrane substrate, wherein one of the two dies has nanoporous holes whereas other of the two dies lacks nanoporous holes;
when the cylindrical-shaped membrane substrate is dry, coating the cylindrical-shaped membrane substrate with at least one layer of zirconium for obtaining a cylindrical ceramic membrane;
sintering the cylindrical ceramic membrane in an inert atmosphere for a given time period; and
coating the cylindrical ceramic membrane with graphene oxide for obtaining the graphene-zirconium dioxide-silicon carbide membrane.

Each of the above-mentioned steps are described below in more detail:

Preparation of the first mixture—In an embodiment, when preparing the first mixture, a paste comprising a mix of multiple raw materials such as silicon carbide (SIC) powder, Zirconium dioxide (ZrO₂) powder, the dispersant, and the solvent, is prepared; the mix is combined and mixed thoroughly; and the binder is added to the mix. As a result, the first mixture is obtained.

Silicon Carbide, also known as carborundum or SiC, is one of the lightest, hardest, and strongest technical ceramic materials. It has exceptional thermal conductivity, resistance to acids, and low thermal expansion. Silicon carbide ceramics' advantages, include, but are not limited to high flux (such as highest flux among ceramic materials), thermal resistance up to 800 degrees, hydrophilic material properties, extremely hard and durable, low power usage and low pressure, long life, and low operational cost.

Formation of the second mixture—In an embodiment, the first mixture is mixed with the liquid such that the second mixture is a homogenous mixture. In other words, the zirconium dioxide and SiC mix will be mixed and blended with the liquid and then the liquid will be added to the homogeneous mixture. The homogenous mixture is an input/feed to an extruder.

Extrusion of the second mixture—In an embodiment, the second mixture is extruded using an extruder. In this regard, the extrusion of the second material is performed for moulding the second mixture into a specific geometry without heating. In an embodiment, the specific geometry is a cylindrical geometry. Once the cylindrical shape is ready, the second mixture is passed through the two dies. Optionally, the two dies are custom-designed dies. When the second mixture is held in the two dies, it would retain that structure (i.e., the cylindrical shape structure defined by the two dies). The second mixture would be held in the two dies until it is dry. A time period for such drying may be several hours, or several days (for example, 2 days), or similar.

Optionally, a size of the nanoporous holes in the one of the two dies that has nanoporous holes is less than 90 nanometers (nm). The other of the two dies does not have any nanoporous holes. Optionally, a diameter of the cylindrical-shaped membrane substrate may be 2 inches, 2.5 inches, 3 inches, 3.5 inches, or similar. Notably, different diameters may be employed for making different batches of the graphene-zirconium dioxide-silicon carbide membrane. Optionally, a length of the cylindrical-shaped membrane substrate may be 21 inches, 15 inches, 40 inches, or similar. These dimensions of the cylindrical-shaped membrane substrate are dimensions of the graphene-zirconium dioxide-silicon carbide membrane. As an example, the graphene-zirconium dioxide-silicon carbide membrane may have a length of 21 inches and a diameter of 2.5 inches.

Coating of zirconium—At least one layer of zirconium may be added to the cylindrical-shaped membrane substrate, as a third phase of graphene-zirconium dioxide-silicon carbide membrane production. In this regard, the steps of preparation of the first mixture, and formation of the second mixture belong to a first phase of said membrane production, whereas the step of extrusion of the second mixture belongs to a second phase of said membrane production. In an embodiment, the at least one layer of zirconium is applied as at least one layer of zirconium dioxide (ZrO₂).

It will be appreciated that Zirconia ceramic, also known as zirconium oxide (ZrO₂), is a white crystalline oxide of zirconium. Its most naturally occurring form is the mineral baddeleyite with a monoclinic crystalline structure. Zirconium oxide ceramics have the highest toughness and strength at room temperature of all advanced ceramic materials. It also has a high thermal expansion, low thermal conductivity, and high resistance to corrosion. Its unique resistance to crack propagation and high thermal expansion make it an excellent material for joining ceramics and metals such as steel. The grade and properties of Zirconia-Zirconia are mixed with calcium oxide (CaO), magnesia (MgO), or yttria (Y2O3) to stabilize in the tetragonal or cubic phase. Partially Stabilized Zirconia (PSZ) consists of cubic, tetragonal, including monoclinic phases of zirconia. Some key properties of zirconia/zirconium dioxide are high mechanical resistance, high-temperature resistance and expansion, low thermal conductivity, chemical resistivity, refractory purposes, thermal barrier coating.

It will be appreciated that zirconium coating (i.e., the coating of the cylindrical-shaped membrane substrate with the at least one layer of zirconium) controls a pore size of the graphene-zirconium dioxide-silicon carbide membrane, and thus, a selectivity of the graphene-zirconium dioxide-silicon carbide membrane. Moreover, the zirconium coating provides ruggedness and durability. The zirconium coating can be added by three different methods: Spray-coating, Dip-coating and Spin-coating.

For example, in the method, dip coating may be performed and zirconium oxide may be dip coated for a thickness of three batches in thicknesses of 2 mm, 4 mm, and 3 mm. More layers (of zirconium) can be added to produce upper layers with higher selectivity. Optionally, the cylindrical-shaped membrane substrate can add up to four to six coating layers of zirconium. The cylindrical-shaped membrane substrate is then again kept to dry again to obtain an even layer of coating. This is essential because an uneven layer will make different parts of one membrane perform differently.

Sintering—A fourth phase of graphene-zirconium dioxide-silicon carbide membrane production is sintering. Sintering involves burning ceramic membranes (such as the cylindrical ceramic membrane) in a high-temperature furnace with an inert atmosphere of very high temperatures (for example, temperatures up to 2100 degrees Celsius) for a specific time period (for example, such as 2-3 days). The process of sintering provides durable physical and chemical properties to the graphene-zirconium dioxide-silicon carbide membrane. In comparison, oxide-based membranes are merely sintered in a furnace of 1200-1600 degrees Celsius.

Coating of graphene oxide—Once the sintering is complete, the graphene oxide is coated onto the cylindrical ceramic membrane. Optionally, in this regard, the graphene oxide (having a pore size lying in a range of 1 nm to 2 nm) as a paste first and then as a powder, is dip coated and then spray coated to the cylindrical (zirconium) ceramic membrane. In an embodiment, a thickness of such coating of graphene oxide lies in a range of 2 mm to 5 mm. Once the aforesaid coating of the graphene oxide is dried, the cylindrical ceramic membrane is spray coated with graphene oxide (GO). After a final coating of graphene oxide, the graphene-zirconium dioxide-silicon carbide membrane is obtained. Optionally, the method for preparing the graphene-zirconium dioxide-silicon carbide membrane further comprises drying the graphene-zirconium dioxide-silicon carbide membrane for a predefined time period. This predefined time period may be 48-72 hours.

Graphene oxide (GO) enables production of new and unique membranes and filters. These solutions improve human health by enabling access to clean water, when they are employed for water filtration. Graphene can be used as an additive within other materials to enhance a variety of technical properties such as electrical conductivity, strength, weight reduction, fire resistance, durability, flexibility, stiffness, and UV resistance.

In an embodiment, Graphene Oxide grade, form, and other properties pursuant to embodiments of the present method are: Form—Paste and powder, Purity->99%, and Pore size—1 nm to 2 nm. In the present disclosure, the term “graphene oxide” encompasses pure graphene oxide, as well as advanced ceramic materials (ACM) graphene oxide composite, as well as any other form of graphene oxide.

It will be appreciated that the graphene-zirconium dioxide-silicon carbide membrane can be employed for several applications. Examples of such applications include, but are not limited to, water filtration (for example, wastewater filtration), desalination, recycling brackish water by food and beverage industries, pharmaceutical industries, and similar, filtering dirty water for green hydrogen production, shipping industry solutions for freshwater generations, and scrubber cleaning solutions for the marine industry.

In an embodiment, when the graphene-zirconium dioxide-silicon carbide membrane is employed for wastewater filtration purposes, the process of wastewater filtration is made more sustainable, efficient, and effective. Since the graphene-zirconium dioxide-silicon carbide membrane is generated by combining graphene oxide and advanced ceramic materials (ACM) Graphene Oxide composite with a combination of Zirconium dioxide and SiC, said membrane is sustainable.

It is known that the world is facing an acute water crisis. Every day more and more wastewater is generated and going untreated (for example as much as 179 billion cubic meters globally). The graphene-zirconium dioxide-silicon carbide membrane provides an extremely useful, effective, solution for wastewater filtration purposes, thus greatly benefitting the environment and causing a massive a massive social and economic impact. The graphene-zirconium dioxide-silicon carbide membrane of the present disclosure provides up to 40 percent energy efficiency (when compared to existing solutions for water filtration), 95 percent water production efficiency (as compared to 40 percent water production efficiency of existing reverse-osmosis filtration solutions), antifouling properties (i.e. resistant to calcium and chlorine salts), is capable of more than 40% salt reduction with gravity, is capable of removing Perfluoroalkyl and Polyfluoroalkyl Substances (PFAS), heavy metals, organic compounds like urea and phosphorus, and has a working pressure <119 pounds per square inch (PSI).

A graphene-zirconium dioxide-silicon carbide membrane module (that is to be employed for water filtration) optionally comprises the graphene-zirconium dioxide-silicon carbide membrane, a top nozzle (for fitting in a device), and an outlet (through which filtered, clean water exits said module).

### DETAILED DESCRIPTION OF THE DRAWINGS

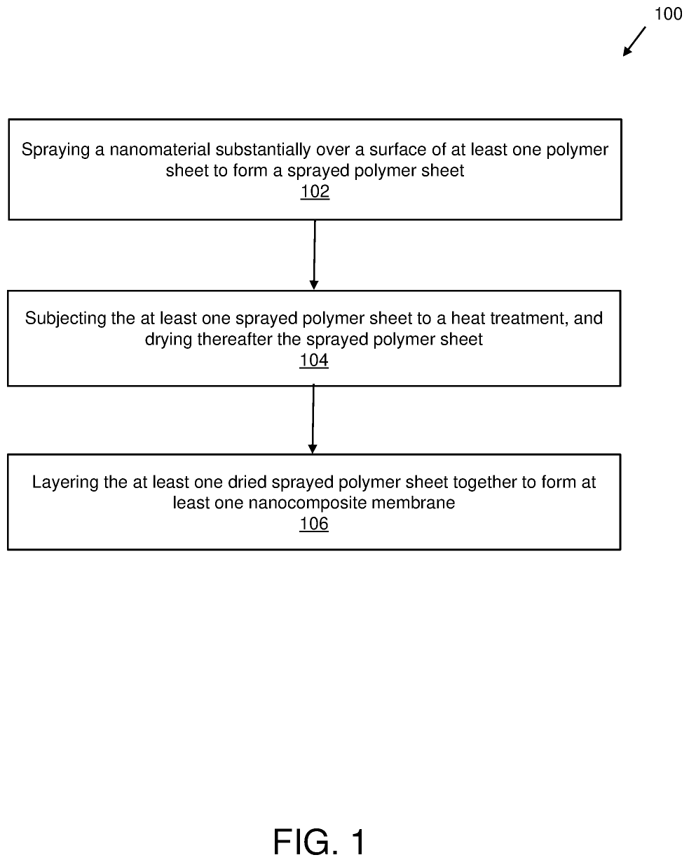

Referring to FIG. 1, there is shown a schematic illustration of a flow diagram of a method 100 for preparing nanocomposite membrane for water filtration, in accordance with an embodiment of the present disclosure. At a step 102, the method comprises spraying a nanomaterial substantially over a surface of at least one polymer sheet to form a sprayed polymer sheet. At step 104, the method comprises subjecting the at least one sprayed polymer sheet to a heat treatment and drying thereafter the sprayed polymer sheet. Furthermore, at step 106, the method comprises layering the at least one dried sprayed polymer sheet together to form at least one nanocomposite membrane.

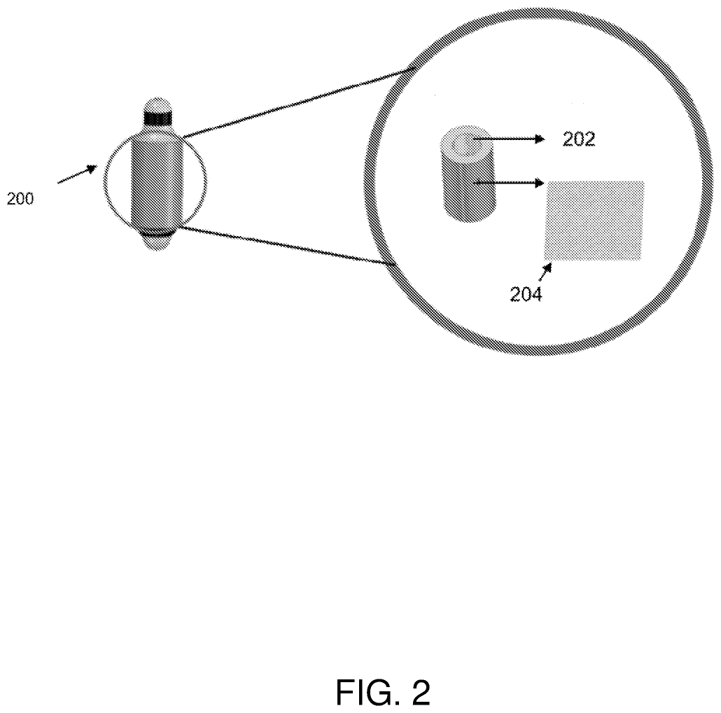

Referring to FIG. 2, there is shown a schematic illustration of a nanocomposite membrane module 200, in accordance with an embodiment of the present disclosure. In an embodiment of the present disclosure, the nanocomposite membrane module 200 is the core part of the water purifier and the key purpose of membrane module is to filter water. The polymer nanocomposite membrane module is composed of a nanomaterial (for example, graphene oxide) sprayed and/or layered over the polymer sheet (for example, polyamide sheet). The sprayed and/or layered polymer sheet with nanomaterial, is together developed to form a sheet 204. The sheet is then layered and rolled or wound around a polymer skeleton structure 202. In an embodiment, the sheets are layered and rolled around a cylindrical structure. In another embodiment, the graphene oxide polyamide nanocomposite membrane sheet is rolled in layers as a cylinder of 5 cm thickness. The cylindrical structure comprises a BPA grade plastic cylindrical skeleton. The food grade plastic cylindrical skeleton is configured to provide support to the nanocomposite membrane sheets to form a proper filtration structure

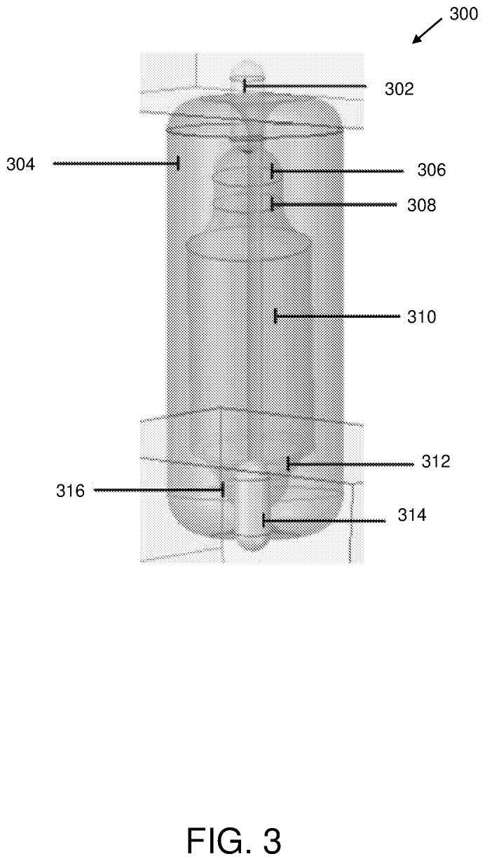

Referring to FIG. 3, there is shown a schematic illustration of a filtration module 300 for water filtration, as in accordance with an embodiment of the present disclosure. The filtration module 300 comprises a casing to filter connecting nozzle 302, an outer casing 304, filter top cap 306, one or more activated charcoal disc 308, a nanocomposite membrane module 310, a filter bottom cap 312 and a connecting nozzle connecting a membrane module 310 to a container connecting nozzle. In an embodiment, the Casing to filter connecting nozzle 302 is a connecting nozzle that is used to transfer water that is to be purified from the dirty water holding container to the outer casing of the filter. The outer casing 304 is the part of the filtration module 300 in which the dirty water is filled and collected. The Filter top Cap 306 is the top part of the filter. In an embodiment, the filter top cap 306 is connected with the membrane module 310 with push fit and interlocked with threads. The filtration module 300 further comprises one or more activated charcoal disc 308 that is connected in between the filter cap 306 and membrane module 310 and is attached to enhance the water purification. The water is passed through said disc once the outer casing 304 is completely filled with the water that is to be purified. The nanocomposite membrane 310 module is the core part of the water purifier and the key purpose of membrane module is to filter water. In an embodiment, the water is purified once the outer casing 304 is completely filled with the dirty water. Since the nanocomposite membrane module 310 is highly permeable in nature, water is passed easily through the sheets wound around the polymer skeleton structure and combined as a module and consequently, the dirty water gets filtered. In another embodiment, the water filtration module 300 further comprises a filter bottom cap 312 that is the bottom part of the filter and is connected with the bottom nozzle connector and the membrane module 310. The water when purified will pass from nanocomposite membrane module 310 to the filter bottom cap 312, the water starts entering the bottom nozzle connector therefrom. In an embodiment, the one or more activated charcoal disc is connected in between the filter bottom cap and the membrane module to container connecting nozzle so as to enhance water purification. Furthermore, the membrane module to container connecting nozzle transfer the purified water from the filtration module to a storage container after the water purification is completed.

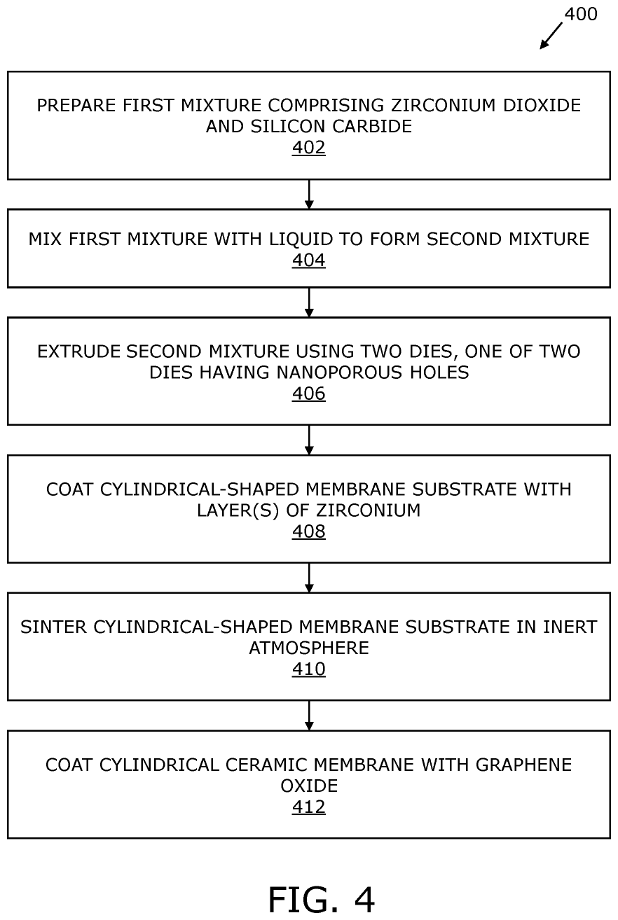

Referring to FIG. 4, illustrated are steps of a method 400 for preparing a graphene-zirconium dioxide-silicon carbide membrane, in accordance with an embodiment of the present disclosure. At step 402, a first mixture comprising zirconium dioxide, silicon carbide, a dispersant, a solvent, and a binder, is prepared. At step 404, the first mixture is mixed with a liquid to form a second mixture. At step 406, the second mixture is extruded using two dies, for obtaining a cylindrical-shaped membrane substrate, wherein one of the two dies has nanoporous holes whereas other of the two dies lacks nanoporous holes. At step 408, when the cylindrical-shaped membrane substrate is dry, the cylindrical-shaped membrane substrate is coated with at least one layer of zirconium for obtaining a cylindrical ceramic membrane. At step 410, the cylindrical ceramic membrane is sintered in an inert atmosphere for a given time period. At step 412, the cylindrical ceramic membrane is coated with graphene oxide for obtaining the graphene-zirconium dioxide-silicon carbide membrane.

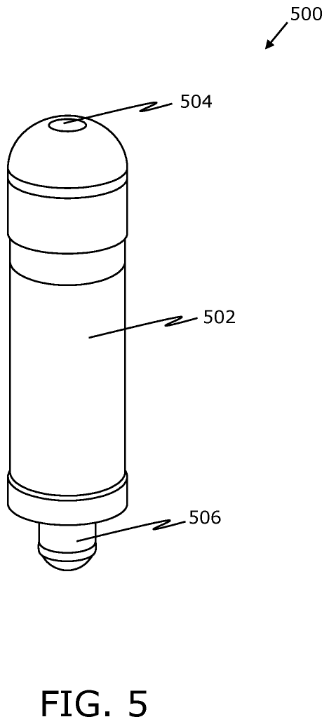

FIG. 5 illustrates an exemplary graphene-zirconium dioxide-silicon carbide membrane module 500, in accordance with an embodiment of the present disclosure. The graphene-zirconium dioxide-silicon carbide membrane module 500 comprises the graphene-zirconium dioxide-silicon carbide membrane 502, a top nozzle 504 (for fitting in a device), and an outlet 506 (through which filtered, clean water exits said module 500).

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of preparing a nanocomposite membrane for water filtration, wherein the method comprising:
spraying a nanomaterial substantially over a surface of at least one polymer sheet to form a sprayed polymer sheet;
subjecting the at least one sprayed polymer sheet to a heat treatment, and drying thereafter the sprayed polymer sheet; and
layering the at least one dried sprayed polymer sheet together to form at least one nanocomposite membrane.

2. The method as claimed in claim 1, wherein the method further comprises winding the nanocomposite membrane around a polymeric skeleton structure.

3. The method as claimed in claim 1, wherein the nanomaterials employed for preparing nanocomposite membrane comprising carbon-based nanomaterials, metal and metallic oxides, non-metallic oxides, metal-organic frameworks and hybrid nanomaterials.

4. The method as claimed in claim 1, wherein the nanomaterials are employed in the form of a cluster, nanotubes, rods, nanosheets, films and polycrystals.

5. The method as claimed in claim 1, wherein the nanocomposite membrane is employed for at least one of a reverse osmosis water filtration process or a forward osmosis water filtration process.

6. The method as claimed in claim 1, wherein the polymer is selected from either a natural polymer or a synthetic polymer.

7. The method as claimed in claim 1, wherein the polymer of the polymer sheet is selected from the group consisting of cellulose-based polymers including cellulose acetate, cellulose triacetate, cellulose acetate proprianate, cellulose butyrate, cellulose acetate propionate, cellulose diacetate, cellulose dibutyrate, cellulose tributyrate, hydroxypropyl cellulose, and nitrocellulose.

8. The method as claimed in claim 1, wherein the polymer of the polymer sheet is selected from the group consisting of polyamide, polybenzimidazole, polyethersulfone, polysulfone, polyvinyl alcohol, polyvinyl pyrrole, polyvinyl pyrrolidone, polyethylene glycol, saponified polyethylene-vinyl acetate copolymer, triethylene glycol, and diethylene glycol.

9. A filter membrane for providing water filtration, wherein the filter membrane comprising:
a polymeric skeleton structure; and
at least one nanocomposite sheet layered together and wound around the polymeric skeleton structure.

10. The filter membrane as claimed in claim 9, wherein the polymeric skeleton structure comprises a BPA grade plastic skeleton structure.

11. The filter membrane as claimed in claim 9, wherein the polymeric skeleton structure is configured to provide support to the at least one polymer nanocomposite sheet.
